(19) United States
(12) Patent Application Publication
(10) Pub. No.: US 2019/0295087 A1
(43) Pub. Date: Sep. 26, 2019

(54) SYSTEM AND METHOD FOR DETECTING FRAUD IN ONLINE TRANSACTIONS BY TRACKING ONLINE ACCOUNT USAGE CHARACTERISTICS INDICATIVE OF USER BEHAVIOR OVER TIME

(71) Applicant: Microsoft Technology Licensing, LLC, Redmond, WA (US)

(72) Inventors: Yuting Jia, Redmond, WA (US); Shoou-Jiun Wang, Sammamish, WA (US); Jayaram NM Nanduri, Issaquah, WA (US)

(21) Appl. No.: 15/934,719

(22) Filed: Mar. 23, 2018

(51) Int. Cl. G06Q 20/40; G06Q 20/32; H04L 29/08; H04W 4/02; G06K 9/62; G06F 15/18

(52) U.S. Cl. CPC G06Q 20/4016; G06Q 20/322; G06F 15/18; H04W 4/025; G06K 9/6215; H04L 67/22

(57) ABSTRACT

Methods, systems, and computer program products are provided for tracking user actions made via a user account, and to accurately detect fraudulent transactions made therewith. Information associated with the user actions such as, for example, device ID, device IP address, and device IP location, is captured and stored. Stored information is used to create features. The features are assembled into an n-dimensional vector, and a measure similarity between that vector and a previously created n-dimensional vector can be computed. The measure of similarity may be used to assess the probability that the present transaction is fraudulent. Alternatively, one or more n-dimensional vectors, and/or the computed measure of similarity may be used as input to a machine learning model. The output of machine learning model also may be used to assess the probability that the present transaction is fraudulent.

### BACKGROUND

Electronic commerce (“E-commerce”) is a form of commerce transacted online, generally via the Internet. E-commerce today is typically conducted over the World Wide Web using a personal computer, smart phone, a tablet computer, or other device that includes a web browser or other Internet-enabled application. The user of one of these devices can navigate to and connect to an e-commerce platform. An e-commerce platform is a form of network accessible system for transacting business, or otherwise providing services to users of the platform. The e-commerce platform enables on-demand access to goods and services online. An e-commerce platform typically consists of a shared pool of computing resources, such as computer networks, servers, storage, applications, and services, that can be rapidly provisioned to, among other things, serve webpages to users, and process user transactions. Notable examples of such e-commerce platforms include, Microsoft® Online Store, Xbox Live®, Amazon.com®, or eBay®.

After connecting to the e-commerce platform, the user may browse through the product or service offerings shown thereon, and opt to purchase one or more of the offered products or services. As part of the transaction, the e-commerce platform will solicit payment from the user, and the user will typically provide credit card or other payment information to effect payment.

Just as with conventional “brick-and-mortar” establishments, however, credit card fraud can be a problem. Indeed, fraud and abuse in the e-commerce context is even more prevalent, due to the virtual presence of the transaction participants. Fraudsters can be physically located virtually anywhere in the world, and need not have a physical credit card or other payment instrument to commit a fraudulent transaction. Fraudsters can also take advantage of hijacked accounts, or other forms of identity theft, in addition to using stolen credit card information. In addition to credit card or other types of financial fraud, e-commerce platforms are also susceptible to other forms of fraudulent abuse as well. Such abuse can cause excessive consumption of storage, processing and human resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided that address issues related to fraud and abuse of an e-commerce platform. In one implementation, a fraud detection system of an e-commerce platform is enabled to collect and store behavior data related to user actions made via the user's account on the e-commerce platform. Behavior data is any information that can be associated with a particular user's account, the actions of the user on the e-commerce platform while using the account, the user's device, user's location and the like. The behavior data is later used to assemble features that reflect, for example, frequency and recency statistics for a given piece of behavior data. The features are assembled into an n-dimensional vector that encapsulates all the behavioral data and statistics related to the user that is available at a given point in time. Over time, the fraud detection system collects and stores additional behavior data associated with the same user account, produces new features from this data, and create a new n-dimensional behavior vector. The two behavior vectors may be compared to one another to generate a measure of similarity. The measure of similarity between the two vectors may be used to assess the probability that a current transaction is fraudulent. In another implementation, the measure of similarity, and/or one or both behavior vectors may be provided as input to a suitable fraud detection model that has been trained with suitable historic fraud related information. The output of the fraud detection model may also be used to assess the probability that a current transaction is fraudulent.

Further features and advantages of the invention, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for detecting fraudulent transactions on an e-commerce platform, according to an example embodiment.

FIG. 2 shows a flowchart of various stages of use of an e-commerce platform, according to an example embodiment.

FIG. 3 shows example behavior data collected by an e-commerce platform when one of the depicted example devices is used to access the platform, according to an example embodiment.

FIG. 4 shows additional data collected by an e-commerce platform that is associated with payment instruments and package shipment, according to an example embodiment.

FIG. 5 shows a flowchart of process steps during a signup stage of use of an e-commerce platform, according to an example embodiment.

FIG. 6 shows a flowchart of process steps during an add payment instrument stage of use of an e-commerce platform, according to an example embodiment.

FIG. 7 shows a flowchart of process steps during a purchase, start trial or start subscription stage of use of an e-commerce platform, according to an example embodiment.

FIG. 8 shows a flowchart of process steps during a usage or consumption stage of use of an e-commerce platform, according to an example embodiment.

FIG. 9 shows a flowchart of a method for creating user behavior features and vectors in an e-commerce platform, according to an example embodiment.

FIG. 10 shows a flowchart of a method for vector comparison in an e-commerce platform, according to an example embodiment.

FIG. 11 shows a flowchart of a method for creating a fraud detection model fraud score in an e-commerce platform, according to an embodiment.

FIG. 12 shows a flowchart of a method for determining a transaction is fraudulent based on historic user behavior patterns, according to an embodiment.

FIG. 13 is a block diagram of an example processor-based computer system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Embodiments described herein enable e-commerce platforms to monitor and record information related to a user's interactions with the e-commerce platform, and detect unusual deviations therefrom during subsequent transactions. Embodiments enable specific types of data to be gathered and recorded, for later transformation into features suitable for use with fraud detection machine learning models. Embodiments also enable consolidation of such features into n-dimensional vectors suitable for comparison with another such vector created at an earlier or later time. In some embodiments, such comparison may yield a measure of similarity between the vectors that may be used to assess the probability that a current transaction is fraudulent. In other embodiments, one or more vectors and/or the measure of similarity may be input to a suitable fraud detection model, the output of such model likewise being used to assess the probability that a current transaction is fraudulent.

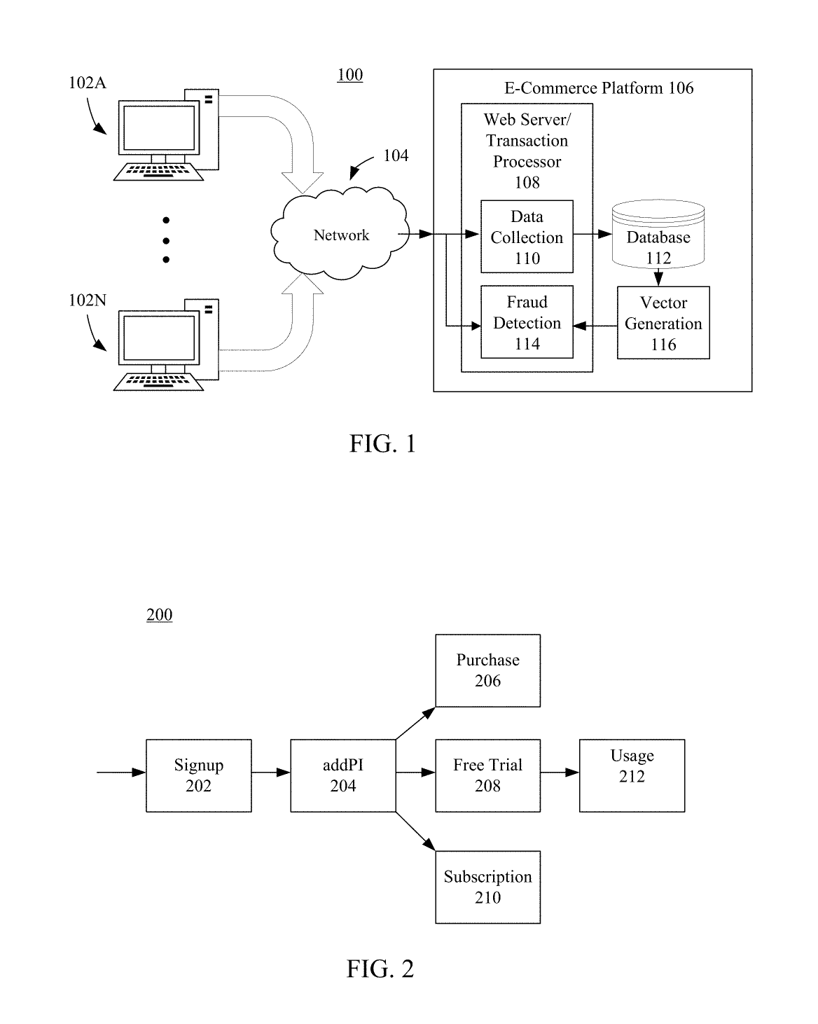

For example, FIG. 1 shows a block diagram of a system 100, according to an example embodiment. System 100 includes a plurality of user devices 102A-102N, a network 104, and an e-commerce platform 106. Note that the variable “N” is appended to reference numerals for illustrated components to indicate that the number of such components is variable, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10s, in the hundreds, in the thousands, or even greater, depending on the particular implementation.

User devices 102A-102N include the computing devices of users (e.g., individual users, family users, enterprise users, governmental users, etc.) that access e-commerce platform 106 via network 104. Although depicted as a desktop computer, user devices 102A-102N may include other types of computing devices suitable for connecting with e-commerce platform 106 via network 104. User devices 102A-102N may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server.

Network 104 may comprise one or more networks such as local area networks (LANs), wide area networks (WANs), enterprise networks, the Internet, etc., and may include one or more of wired and/or wireless portions.

E-commerce platform 106 includes Web server/transaction processor 108, database 112, and vector generation component 116. Web server/transaction processor 108 includes data collection component 110, and fraud detection component 114. Although depicted as a monolithic component, Web server/transaction processor 108 may comprise any number of servers, and may include any type and number of other resources, including resources that facilitate communications with and between the servers, user devices 102A-102N, database 112, and any other necessary components both inside and outside e-commerce platform 106. Servers of Web server/transaction processor 108 may be organized in any manner, including being grouped in server racks (e.g., 8-40 servers per rack, referred to as nodes or “blade servers”), server clusters (e.g., 2-64 servers, 4-8 racks, etc.), or datacenters (e.g., thousands of servers, hundreds of racks, dozens of clusters, etc.). In an embodiment, the servers of Web server/transaction processor 108 may be co-located (e.g., housed in one or more nearby buildings with associated components such as backup power supplies, redundant data communications, environmental controls, etc.) to form a datacenter, or may be arranged in other manners. Accordingly, in an embodiment, Web server/transaction processor 108 may comprise a datacenter in a distributed collection of datacenters. Likewise, although depicted as a single database, database 112 of e-commerce platform 106 may comprise one or more databases that may be organized in any manner both physically and virtually. In an embodiment the servers of database 112 may be co-located in a manner like Web server/transaction processor 108, as described above.

Similarly, although vector generation component 116 is depicted as a standalone component, it will be apparent to persons skilled in the art that operations of vector generation component 116, and as described in further detail below, may be incorporated into, for example, database 112, or Web server/transaction processor 108. For example, vector generation component 116 operations may be incorporated into a stored procedure of an SQL database, in an embodiment.

Operational aspects of system 100 will be discussed in some detail below. What follows immediately hereafter, however, is a discussion of the general operation of an embodiment of system 100. Using a browser on, for example, user device 102A, a user navigates to a URL associated with e-commerce platform 106, and establishes a connection therewith via network 104. At connection time, and at certain other times as described in more detail herein below, data collection component 110 of e-commerce platform 106 actively collects behavior data associated with the user's interaction with e-commerce platform 106, and stores such behavior data in database 112. Behavior data is typically stored in association with an account ID, device ID or some other useful means for associating the behavior data with a particular user or user account, and to facilitate later retrieval. In one embodiment, for example, and as discussed in more detail below, data collection component 110 may note the IP address and IP address geolocation (i.e. the geographic location on earth of the IP address in question) of user device 102A, and store that information in database 112. Over time, as the user makes additional connections with or uses of e-commerce platform 106 for various purposes, data collection component 110 will collect and store additional behavior data associated with each of these connections and uses. Thusly, e-commerce platform 106 comes to have a body of historical usage data associated with each user.

Vector generation component 116 subsequently retrieves the behavior data from database 112, and creates features from the data that reflect various usage statistics of the user. For example, the retrieved behavior data may include the set of every IP address that the user has used to connect to e-commerce platform 106 over the last 3 months. Vector generation component 116 compares the user's current IP address to the set of historical IP addresses, and computes, for example, frequency and recency features therefrom. In this particular example, vector generation component 116 may compute a feature that reflects the number of days since the first time the user connected from the current IP address, or reflects the total number of transactions the user has conducted over the last 3 months using the current IP address, and the like.

Vector generation component 116 is further configured to assemble all such computed features into an n-dimensional vector that represents the user's behavior patterns over the 3 month period of time (referred to hereinafter as a “behavior vector”). Vector generation component 116 is further configured to store the behavior vector in database 112 for later retrieval.

At a later time, when the user attempts to execute a transaction on e-commerce platform 106, vector generation component 116 creates new features, and a new behavior vector that reflects the pattern of the user's more recent use of e-commerce platform 106. In an embodiment, for example, the new behavior vector may be generated from behavior data collected and stored over the last week. The previously stored behavior vector, and the new behavior vector created during the pending transaction are provided to fraud detection component 114.

Fraud detection component 114 is configured to generate a measure of similarity between the provided behavior vectors. If the provided behavior vectors are sufficiently dissimilar, as reflected in the measure of similarity, it is more likely that the current transaction is fraudulent, and fraud detection component 114 may flag the current transaction as fraudulent, and cancel the transaction. In an embodiment, fraud detection component 114 may be configured to input one or both behavior vectors, and/or the generated measure of similarity to a fraud detection model suitably trained for fraud detection. The output of fraud detection model, may then also be used either entirely or in part to determine that the pending transaction is fraudulent. Note that foregoing general description of the operation of system 100 stands as one example only, and embodiments of system 100 may operate in a manner different than described above. Furthermore, not all such processing steps need be performed in all embodiments. What follows is discussion of the remaining figures wherein detailed operational specifics of various embodiments of system 100 will be apparent.

In embodiments, e-commerce platform 106 of system 100 may be used in various ways by a user. For instance, FIG. 2 shows a flowchart 200 of typical stages of use of e-commerce platform 106, according to an example embodiment. Although many e-commerce platforms permit people to use certain aspects of the platform without creating an account or otherwise signing up (e.g. browsing through and/or searching for products or services on the platform), any sort of transaction will typically require the user to create an account as depicted in signup stage 202 of FIG. 2. At this stage, the user will generally provide at least an email address and password they wish to use with e-commerce platform 106, and may be asked to provide more information depending on the particulars of the platform.

In an embodiment, the next stage of use of e-commerce platform 106 requires the user to associate a payment instrument with their account at addPI (which means “add payment instrument”) stage 204. In other embodiments, however, e-commerce platform 106 may not require the user to enter payment instrument information until a later stage, such as checkout. In flowchart 200, however, it is assumed the addPI stage is required prior to entering one or more of transaction stages 206, 208 or 210. In an embodiment, at addPI stage 204, the user enters, for example, a credit card number, expiration date of the credit card, and the CVV value associated with that card, and e-commerce platform 106 saves that information to the user's account. In another embodiment, the user may instead enter information associated with a gift card or gift certificate, or establish some other means of paying for goods and services such as providing bank account and ACH routing numbers.

After adding a payment instrument to the account, process flow may continue to one or more of transactions stages 206, 208 or 210 in flowchart 200. In particular, the user may elect to make a purchase 206, start a free trial 208 or start a subscription 210. A purchase 206 is generally associated with the procurement of goods such as books or other merchandise including downloadable merchandise such as software, music or movies. A free trial 208 or subscription 210, by contrast, is generally associated with a service provided by or in association with e-commerce platform 106. For example, Microsoft® Xbox Live® is an online multiplayer gaming and digital media delivery service. A subscription to Xbox Live® is required to participate in many popular online multiplayer games. Subscriptions services like Xbox Live® are often offered on a free trial basis allowing users to evaluate the usefulness and value of the service prior to signing up for a subscription. Bearing this example in mind, after addPI stage 204, a user may enter free trial stage 208 to signup up for a free trial of the service. Alternatively, or perhaps sometime after free trial stage 208, the user may elect to pay for a subscription at subscription stage 210. Naturally, usage stage 212 would follow any of purchase stage 206, free trial stage 208 or subscription stage 210. That is, the service or product is bought or subscribed to in one or more of transaction stages 206, 208 or 210, is used or otherwise consumed in usage stage 212.

At each of stage 202-212, embodiments may collect and store behavior data associated with each stage or transaction. For example, and as discussed briefly above, e-commerce platform 106 of FIG. 1 may capture the IP address and IP address geolocation of user device 102A during each stage of use depicted in flowchart 200. It should be understood, however, that the IP address and IP address geolocation of are only two examples of user behavior data that may be collected and stored by e-commerce platform 106. It should likewise be understood that behavior data that is collected and stored does not necessarily correspond to a particular user, but rather the use of a particular account. Indeed, embodiments may detect fraudulent activities with, for example, a hijacked account where the “user” is not the owner of the account, but a fraudster at some other location.

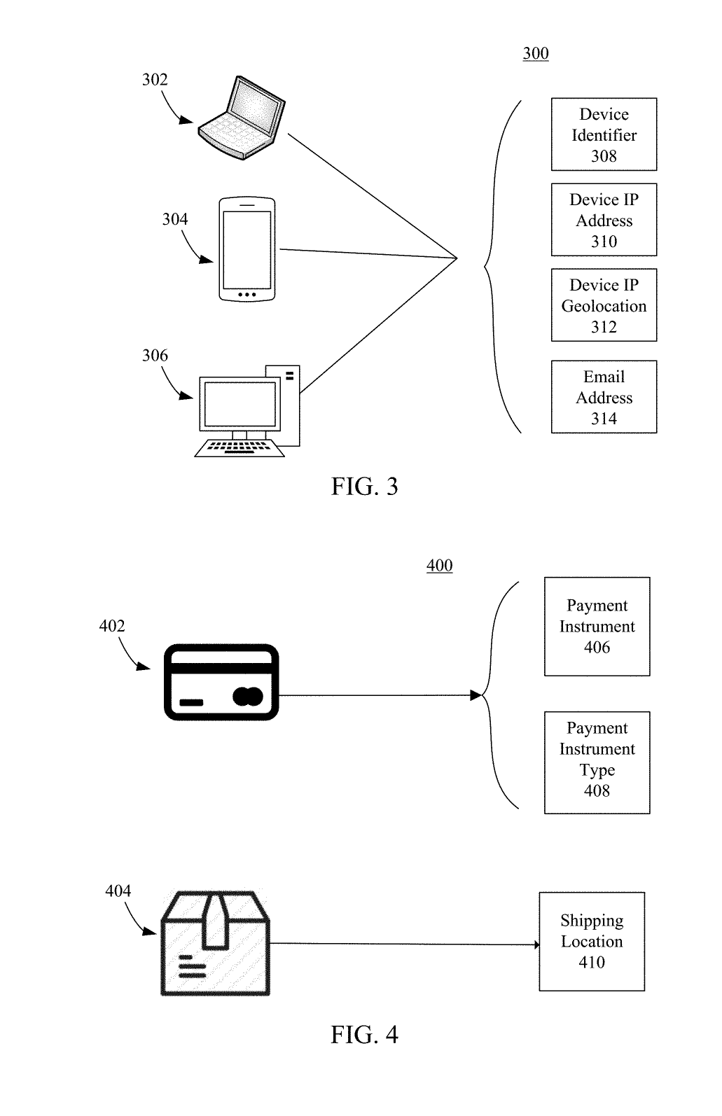

As described above, e-commerce platform 106 may collect and store many types of user behavior data. For instance, FIGS. 3 and 4 show additional example user behavior data that may be collected in one or more embodiments. Referring now specifically to FIG. 3, user devices 302, 304, and 306 illustrate the varying means by which a user may connect to e-commerce platform 106. As discussed above, a user may connect to e-commerce platform 106 using, for example, laptop 302, smart phone 304, or desktop computer 306. At connection time, and during any stage of use depicted in flowchart 200, data collection component 110 may collect and store any of user behavior data 308 through 314.

Device identifier 308 as depicted in FIG. 3, is behavior data that uniquely identifies the device used to connect to e-commerce platform 106. Device identifier 308 can be used to determine, for example, whether the user has connected using laptop 302, or smart phone 304 even where all other usage data collected in different sessions or stages is otherwise identical. Device identifier 308 is synonymous with “device fingerprint” or “machine fingerprint,” as known in the art. Various means of generating a unique device identifier 308 are likewise known in the art.

Device IP address 310 is simply the IP address of the user device used to connect to e-commerce platform 106. Likewise, device IP geolocation 312 is an estimate or identifier of a geographic location of device IP address 310 as known in the art.

Lastly, whenever any user action taken on e-commerce platform 106 can be accurately associated with an email address 314, that behavior data is also collected and stored. Indeed, each of the stages of use depicted in flowchart 200 of FIG. 2 require the user to login to his/her account having an email address associated therewith. Changes to the associated email address 314 would be reflected in collection and storage of behavior data during later transactions.

We turn now to FIG. 4 that shows additional example behavior data that may be collected in one or more embodiments. More specifically, credit card 402 illustrates an example payment instrument in an embodiment. During addPI stage 204 as discussed above, e-commerce platform 106 will collect and save behavior data associated with payment instrument 406 and payment instrument type 408. For example, behavior data associated with payment instrument 406 may include a credit card number, expiration date, CVV number, billing address, billing phone number and so forth as is typically required for e-commerce or telephone based credit card transactions. Where payment instrument 406 is associated with a credit card, payment instrument type 408 will reflect that fact. In an embodiment, and where payment instrument 406 is, for example, a credit card, payment instrument type 408 may indicate the type of credit card. In other embodiments, payment instrument 406 and payment instrument type 408 may comprise data associated with a gift certificate, a PayPal® account, an EFT/ACH routing number and checking account number, or any other means of paying for goods and services. FIG. 4 also depicts package 404 representing merchandise to be shipped to a specific address. Where the user purchases physical goods that require delivery, a shipping address is of course required. One or more embodiments may save shipping location 410 as behavior data. In so doing, e-commerce platform 106 can track the shipping history of a customer and readily detect changes to the delivery address that may signify fraud.

It is noted that the types of behavior data collected by e-commerce platform 106 should not be limited to those depicted in FIGS. 3 and 4, and as discussed above. Instead, behavior data may include any type of data or information associated with user actions conducted via a user account of an e-commerce system.

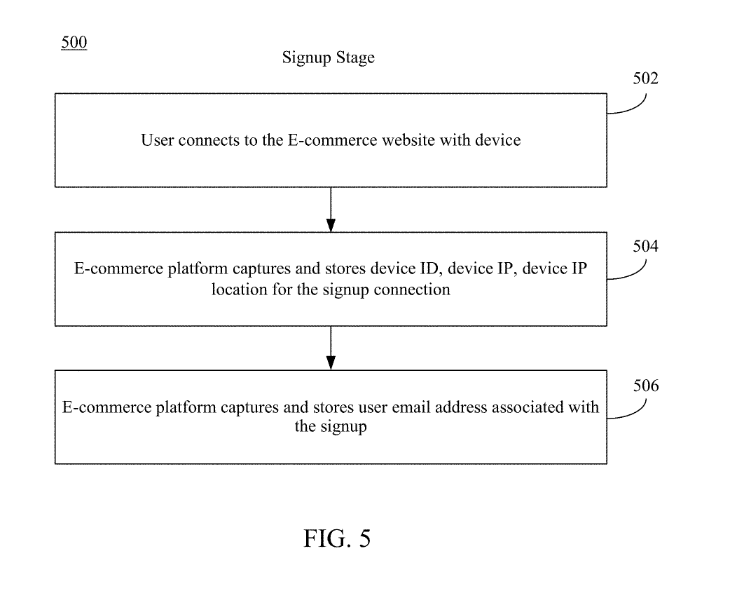

As discussed in part above, in one or more embodiments, e-commerce platform 106 may collect behavior data associated with user actions conducted via their account on e-commerce platform 106. Such actions may, for example, occur during the stages of use as depicted in FIG. 2 and discussed above. For instance, FIGS. 5-8 depict flowcharts 500-800, respectively, illustrating the process for collecting behavior data during the stages of use shown in FIG. 2, as well as examples of such behavior data. Note that the steps of flowcharts 500-800 may be performed in an order different than shown in some embodiments. Furthermore, not all steps of flowcharts 500-800 need to be performed in all embodiments. Further operational embodiments will be apparent to persons skilled in the relevant art based on the following descriptions of flowcharts of 500-800.

Flowchart 500 of FIG. 5 shows a process for collecting behavior data during the sign-up stage 202 as shown in FIG. 2. Flowchart 500 begins with step 502. In step 502, a user connects to e-commerce platform 106 with a device. For example, a user may use a web browser or other Internet-enabled application on a suitable device to navigate to a URL associated with e-commerce platform 106. Continuing to step 504, even before the user takes any action after connecting to e-commerce platform 106, e-commerce platform 106 can capture and store behavior data such as a device ID, device IP, and device IP location associated with the user's device for that connection. In an embodiment, e-commerce platform 106 stores such behavior data in database 112 as shown in FIG. 1. In an alternative embodiment, e-commerce platform 106 may store such behavior data in a cookie stored on the user's device for later retrieval and processing by e-commerce platform 106 during the user's subsequent connections to the platform. Such an embodiment may usefully permit e-commerce platform 106 to track use of the platform even when the user actions are not taken in conjunction with a particular account (e.g. browsing without first logging in). In step 506, embodiments of e-commerce platform 106 capture and store the user email address associated with the user, as entered during the sign-up process. In other embodiments, e-commerce platform 106 may also capture and store other relevant and useful information associated with the user as provided by the user during the sign-up process.

After signup stage 202 of FIG. 2 is complete, a user may login to the newly created account. Indeed, this may happen any number of times for a variety of reasons. In an embodiment, e-commerce platform 106 may capture and store one or more of device ID, device IP address or device IP geolocation, in addition to other relevant behavior data. However, before the user can complete a transaction on e-commerce platform 206, the user must add a payment instrument to his or her account.

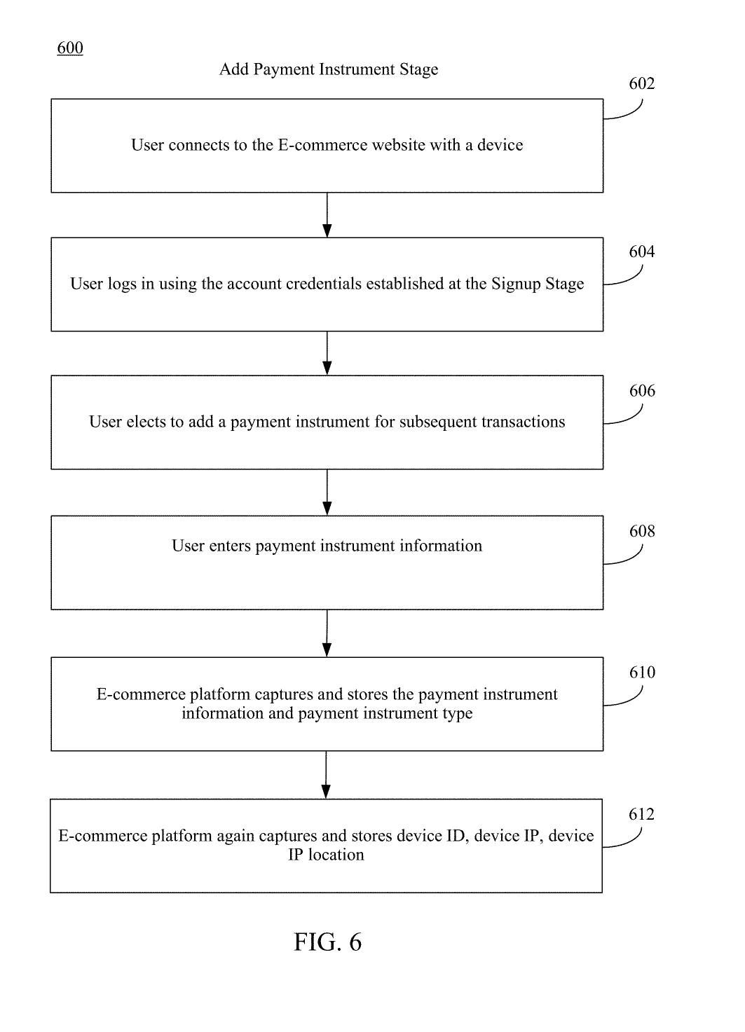

An example process for collecting behavior data during the add payment instrument (“addPI”) stage 204 of FIG. 2 is shown in flowchart 600 of FIG. 6. Flowchart 600 begins with step 602. In step 602, a user connects to e-commerce platform 106 with a device. This may be accomplished through the use of a web browser or other Internet-enabled application as discussed above. At step 604, the user logs in using the account credentials established at sign-up stage 202. Assuming, as we do, that the user wishes to transact business on e-commerce platform 106, the user will elect to add a payment instrument for subsequent transactions at step 606. The user is now required to provide payment instrument information at step 608. This may be accomplished by the user providing credit card information as discussed above. Flowchart 600 continues at step 610 where e-commerce platform 106 stores payment instrument information and payment instrument type also as discussed above. Flowchart 600 concludes at step 612, with e-commerce platform 106 again capturing and storing the device ID, device IP, and device IP geolocation of the user's device. Note that the steps of flowcharts 600 may be performed in order different than shown in some embodiments. For example, the behavior data captured and stored at step 612 may instead be captured and stored earlier in the process flow. Indeed, such behavior data can be captured at any time including before the user has had an opportunity to log in to e-commerce platform 106.

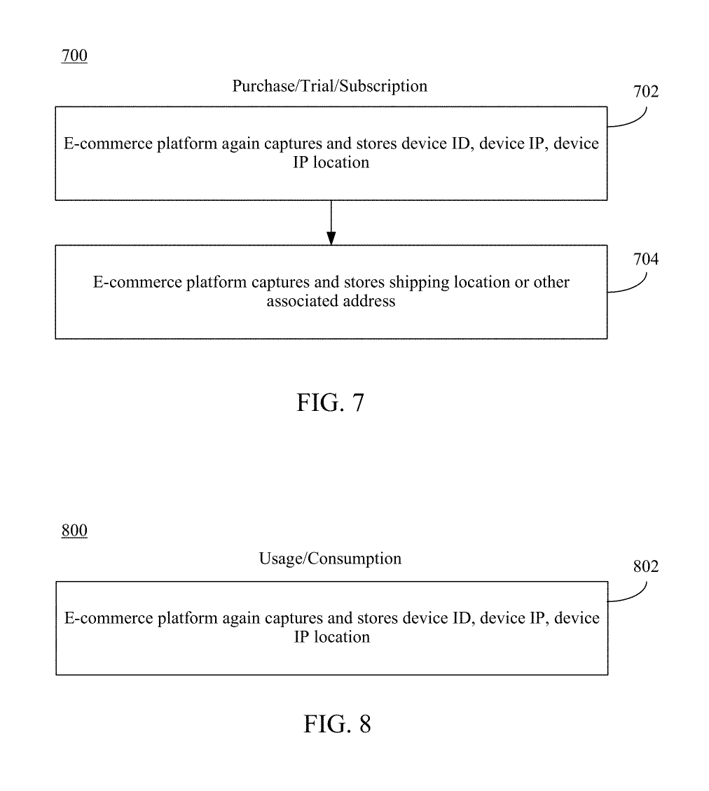

As discussed above, e-commerce platform 106 may collect behavior data during any of purchase stage 206, free trial stage 208, or subscription stage 210 as shown in FIG. 2. Flowchart 700 of FIG. 7 shows a process for collecting such behavior data. Flowchart 700 begins at step 702. Step 702 shows that e-commerce platform 106 may be configured in some embodiments to capture and store behavior data comprising any or all of device ID, device IP, and device IP geolocation. At step 704, and assuming that the user action requires the user to provide a shipping location, e-commerce platform 106 captures and stores behavior data reflecting such shipping address or other associated address. One of skill in the art will recognize, that steps 702 and 704 of flowchart 700 may be performed in any order.

Of course, a user of e-commerce platform 106 may perform a number of actions that are not encompassed by those described in conjunction with FIGS. 5-7. Flowchart 800 of FIG. 8 depicts the collection of behavior data during such alternative uses of e-commerce platform 106. For example, where the user connects to e-commerce platform 106 for the purpose of using a previously purchased subscription, none of the previously discussed stages of use 202-210 of FIG. 2 are applicable. Nevertheless, e-commerce platform 106 will capture and store behavior data that at least reflects the device ID, device IP, and device IP geolocation of the user's device.

Much of the foregoing has been dedicated to describing the various types of user behavior data that e-commerce platform 106 can collect and store during various use stages of the platform. What follows will discuss how the stored user behavior data may be used by e-commerce platform 106 to help detect fraudulent transactions. Flowchart 900 as shown in FIG. 9 describes a process by which e-commerce platform 106 may use the stored user behavior data to create behavior features therefrom, and in turn create an n-dimensional vector from the created behavior features. Flowchart 900 begins at step 902. In step 902, the process begins with e-commerce platform 106 retrieving previously stored behavior data. As discussed above, behavior data collected and stored by e-commerce platform 106 may comprise any of a device identifier, a device IP address, and device IP address geolocation, an email address, a payment instrument, a payment instrument type, or a shipping location. Whether e-commerce platform 106 collects any or all of the aforementioned behavior data will depend on the particular use being made of e-commerce platform 106, and as discussed above in conjunction with FIGS. 5-8, as well as the characteristics of the embodiment being employed. After retrieving stored behavior data in step 902, process flow continues with step 904.

At step 904, embodiments may create behavior features using the retrieved behavior data. For example, supposing e-commerce platform 106 previously stored the device identifier of the user, one or more components of e-commerce platform 106 may retrieve all records of the stored device ID, and to compute one or more behavior features. As discussed above, the device ID is a device fingerprint that uniquely identifies the device the user is employing to connect e-commerce platform 106. In this example, e-commerce platform 106 may create features that, for example, reflect the user's first use of that device, the user's most recent use of that device, the total number of times the user has used that device, or the total dollar amount spent using the device. Such usage statistics, or features, may be computed for any of the various types of behavior data collected and stored as described in conjunction with FIGS. 5-8 above. By way of further example, e-commerce platform 106 may create features that reflect the user's first use of a particular payment instrument, the user's most recent time use of that instrument, the number of times the user has used that instrument, or the total dollar amount spent using the payment instrument.

It is noted that the behavior features computed in step 904 need not reflect the entire behavior history of the user. In an embodiment, the behavior features may be computed based on behavior history associated with, for example, the last 30, 60, 90 or some other predetermined number of days.

Embodiments may assemble an n-dimensional vector from the computed behavior features. For example, suppose that e-commerce platform 106 computed nine behavior features at step 904, Then, if we let θ₁, θ₂, θ₃, θ₄, θ₅, θ₆, θ₇, θ₈, θ₉ equal each of the nine computed behavior features, then the n-dimensional behavior vector associated with those features can be expressed as a 9 dimensional vector V that equals <θ₁, θ₂, θ₃, θ₄, θ₅, θ₆, θ₇, θ₈, θ₉>. E-commerce platform 106 then stores the computed n-dimensional behavior vector at step 906, for later use in detecting a fraudulent transaction as described more fully below.

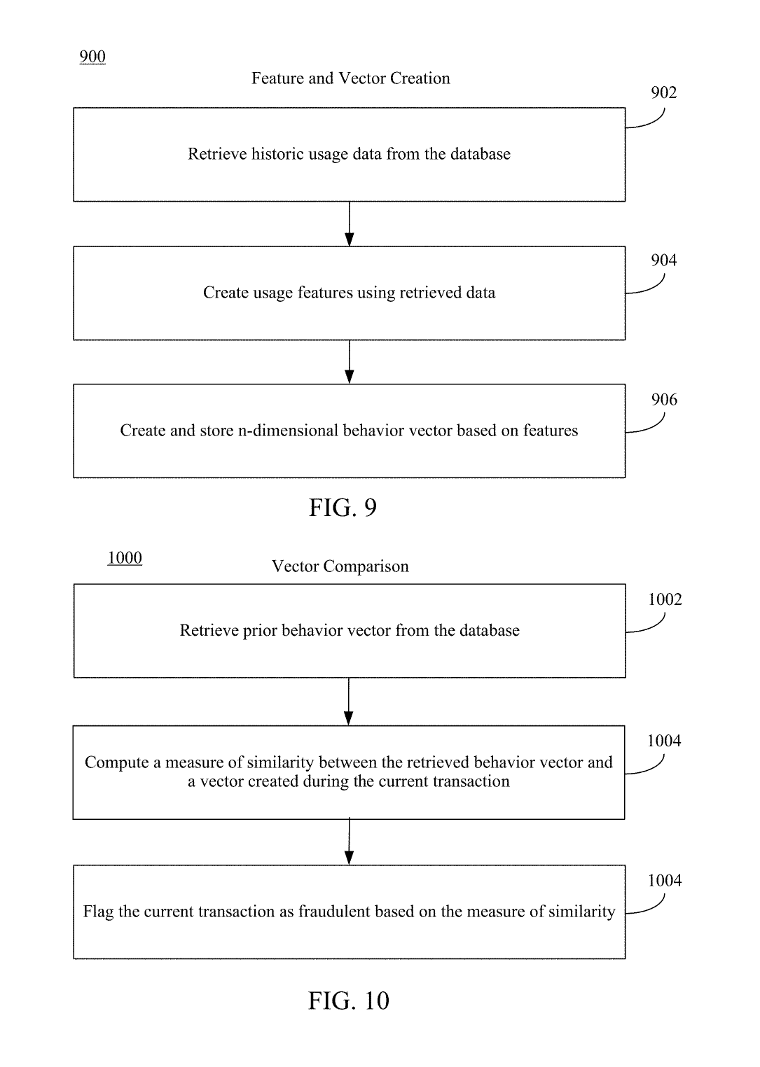

In embodiments, e-commerce platform 106 of system 100 may operate in various ways to detect fraudulent transactions. For instance, FIG. 10 shows a flowchart 1000 of a process for detecting fraudulent transactions, according to an example embodiment. Note that the steps of flowchart 1000 may be performed in an order different than shown in FIG. 10 in some embodiments. Furthermore, not all steps of flowchart 1000 need to be performed in all embodiments. Further operational embodiments will be apparent to persons skilled in the art based on the following description flowchart 1000 and e-commerce platform 106.

Flowchart 1000 begins with step 1002. In step 1002, e-commerce platform 106 may retrieve the previously computed n-dimensional behavior vector from storage such as database 116 of system 100. It is assumed for the purposes of flowchart 1000, that the user is currently in the process of executing a transaction on e-commerce platform 106. Accordingly, e-commerce platform 106 computes a new behavior vector based either on more recently stored behavior data, or behavior data gathered during this transaction, or both. At step 1004, an embodiment of e-commerce platform 106 will compute a measure of similarity between the old behavior vector retrieved at step 1002, and the new vector created during this transaction.

As is known in the art, there are number of methods for computing a measure of similarity between two n-dimensional vectors. For example, cosine similarity is a scalar measure similarity between two nonzero vectors that reflects the cosine of the angle between the vectors. That is, two vectors have a cosine similarity of 1 where the angle between them is 0°. Conversely, two vectors have a cosine similarity of zero where the angle between them is 90°. Thus, as cosine similarity between two vectors approaches 1, vectors are judged to be more similar. Alternative embodiments of e-commerce platform 106 may be configured compute a measure of similarity using other types of analysis as is known in the art. For example, e-commerce platform 106 may perform earth mover's distance based similarity analysis, locality sensitive hashing analysis, or random projection analysis.

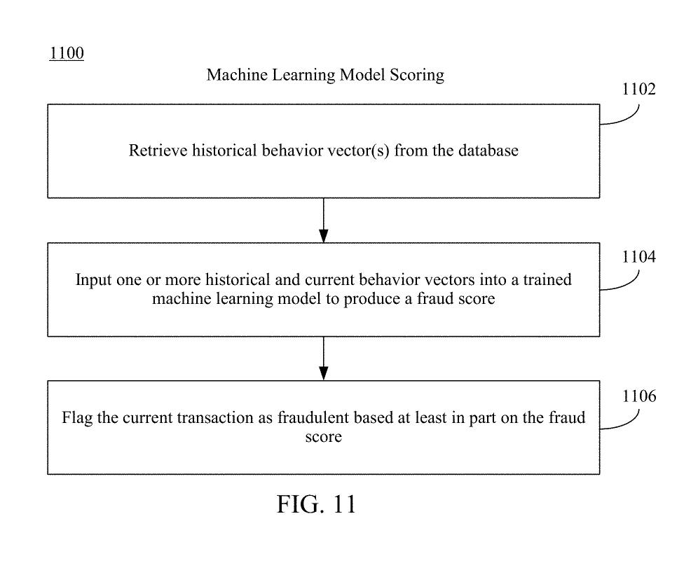

Process flow continues at step 1004 of FIG. 10 wherein the measure of similarity is used, at least in part, to determine that the current transaction is fraudulent. For example, suppose e-commerce platform 106 computes the cosine similarity of the old and new n-dimensional behavior vectors at step 1004, and produces a cosine similarity score of 0.01. Such a low similarity score would tend to indicate that the old and new n-dimensional behavior vectors are quite different. Such vectors will be substantially different where the underlying behavior features that comprise the behavior vector also display one or more substantial differences. For example, suppose that during the pending transaction that the user has connected to e-commerce platform 106 from an IP address located in Europe. Further suppose that for all other actions and/or transactions undertaken by the user on e-commerce platform 106, the user connected from an IP address located in the United States. Such a large difference between IP address locations in the past versus the current transaction would tend to be a strong indicator of fraud, and that difference is reflected in the behavior vector from the past versus the behavior vector computed during the transaction. The computed measure of similarity, therefore, may be used at least in part to determine that the current transaction is fraudulent. As discussed in relation to FIG. 11 below, however, embodiments may also use a fraud detection model to further determine whether a transaction may be fraudulent.

In embodiments, e-commerce platform 106 of system 100 may operate in various ways to detect potentially fraudulent transactions. For instance, FIG. 11 shows a flowchart 1100 of a process for using a fraud detection model to determine a transaction is fraudulent, according to an example embodiment. Flowchart 1100 is described with respect to e-commerce platform 106 of system 100 for illustrative purposes only. Note that the steps of flowchart 1100 may be performed in order different than shown in FIG. 11 in some embodiments. Furthermore, not all steps of flowchart 1100 need to be performed in all embodiments.

Flowchart 1100 begins at step 1102. In step 1102, e-commerce platform 106 may retrieve a previously computed n-dimensional behavior vector from storage such as database 116 of system 100. Also in step 1102, as in flowchart 1000 of FIG. 10, e-commerce platform 106 will compute a new behavior vector based either on more recently stored behavior data, or behavior data gathered during this transaction, or both. In another embodiment, e-commerce platform 106 may also compute a measure of similarity (as discussed in detail above) at step 1102.

Continuing to step 1104, e-commerce platform 106 may input any combination of the new behavior vector computed during the transaction, the old behavior vector retrieved from storage or the measure of similarity into a fraud detection model. In an embodiment, step 1104 may be performed by fraud detection module 114 of e-commerce platform 106 as depicted in FIG. 1. In one embodiment, the fraud detection model may be a machine learning model such as a gradient boosting decision tree, an artificial neural network, a deep neural network or some other type of machine learning classifier. Accordingly, the disclosed embodiments are not limited by any particular type of fraud detection model employed by, for example, fraud detection module 114 of e-commerce platform 106.

In performing step 1104 of flowchart 1100, embodiments may determine a fraud score for the pending transaction using a fraud detection model as discussed above. Not unlike the measure of similarity, a fraud score may be of the probability whether the current transaction is fraudulent and should be rejected if the score is high enough. At step 1106, an embodiment such as, for example, e-commerce platform 106 of FIG. 1 may determine that the current transaction is fraudulent based at least in part on the fraud score computed by fraud detection module 114.

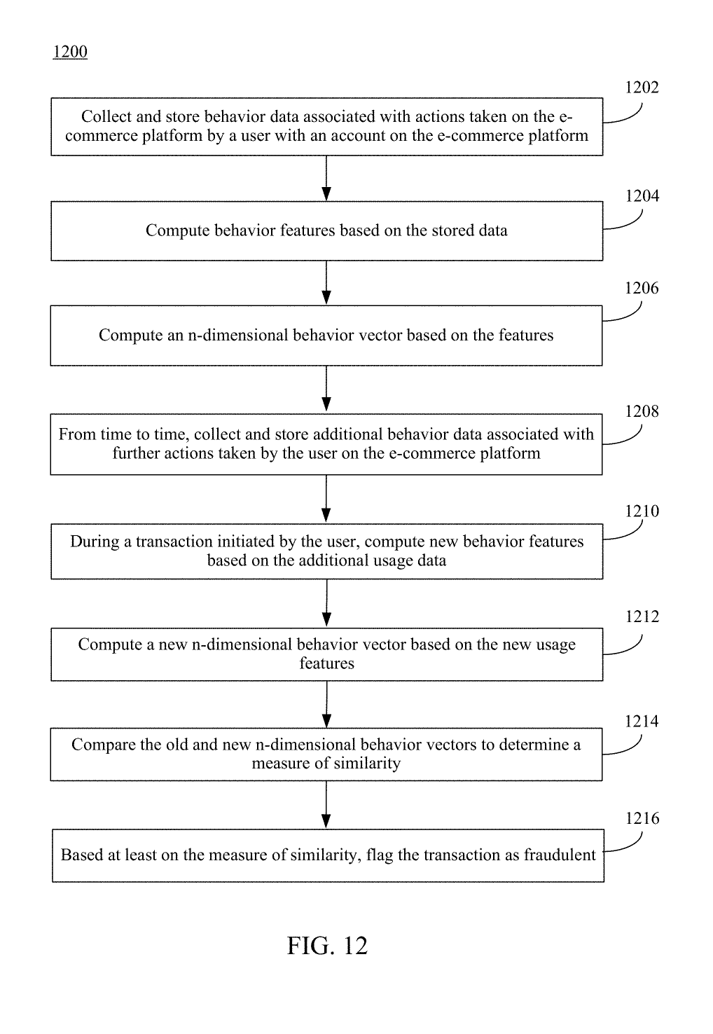

In embodiments, e-commerce platform 106 of system 100 may operate in various ways to detect fraudulent transactions. For instance, FIG. 12 shows a flowchart 1200 describing a method for detecting fraud in e-commerce platform 106 of system 100 in one embodiment. Note that the steps of flowchart 1200 may be performed in an order different than shown in FIG. 12 in some embodiments. Furthermore, not all steps of flowchart 1200 need to be performed in all embodiments.

Flowchart 1200 begins at step 1202. In step 1202, e-commerce platform 106 may collect and store behavior data associated with actions taken by a user with a user account on e-commerce platform 106. Such actions in step 1202 may comprise one or more of, signing up for the user account, adding a payment instrument to the user account, making a purchase with the user account, starting a free trial with the user account, or starting a subscription with the user account. In the event that the user has already made a purchase, or started a free trial or subscription with the user account, user actions taken in step 1202 may further comprise making use of the purchase, free trial, or subscription. The behavior data collected and stored by e-commerce platform 106 may comprise any of a device identifier, a device IP address, and device IP address geolocation, an email address, a payment instrument, a payment instrument type, or a shipping location.

Flowchart 1200 continues at step 1204. In step 1204, one or more components of e-commerce platform 106 will compute behavior features based on the stored behavior data, and as discussed in detail above in conjunction with flowchart 900 of FIG. 9.

At step 1206 of flowchart 1200, e-commerce platform 106 may assemble an n-dimensional behavior vector based on the previously computed behavior features, a detailed discussion of which can be found above in conjunction with flowchart 900 of FIG. 9.

Steps 1208, 1210, and 1212 of flowchart 1200 are analogous to steps 1202, 1204, and 1206, respectively. In particular, steps 1208, 1210 and 1210 each proceed in the same manner as their respective analogous steps, except they typically occur at a later time. At step 1208, for example, e-commerce platform 106 will collect and store additional behavior data associated with any further actions taken by the user of the same account. Stored additional behavior data will be used later as discussed in more detail herein below.

At step 1210, the user initiates a transaction on e-commerce platform 106. In response, e-commerce platform 106 will compute new behavior features based at least in part on the additional behavior data collected and stored at step 1208. Just as with step 1204, the new behavior features may be computed based on usage history associated with a predetermined number of days. In the case of real time fraud detection, e-commerce platform 106 typically will compute the new behavior features based on relatively small number of days of historical behavior data, or even based exclusively on behavior data gathered that day during the transaction.

E-commerce platform 106 may assemble a new n-dimensional behavior vector based on the new behavior features at step 1212. The manner of assembling such a vector may be identical to that described above in conjunction with step 1206. At the conclusion of step 1212, e-commerce platform 106 has two n-dimensional vectors, one based on behavior data gathered over a relatively long period of time in the past, and one based on behavior data gathered in the recent past.

As discussed in detail above in conjunction with flowchart 1000 of FIG. 10, the manner in degree to which these vectors differ can serve as a means of identifying a fraudulent transaction. At step 1214, e-commerce platform 106 will determine a measure of similarity between the old and new n-dimensional behavior vectors.

At step 1216, e-commerce platform 106 will determine that the current transaction is fraudulent based at least on the measure of similarity as discussed in more detail above.

The foregoing systems and methods enable the detection of fraud in online transactions to be carried out accurately and in a manner that leverages data collected over various stages of user interaction with an e-commerce platform. Responsive to detection of a fraudulent transaction, the e-commerce system can take any number of actions, including but not limited to, generating an alert, halting or terminating a transaction, cancelling a user account, flagging a transaction as fraudulent, or the like. The systems and methods described herein can greatly improve the performance of the various computers that make up an e-commerce platform by, for example, reducing the processing and storage associated with fraudulent online transactions by halting such transactions before they can be carried out or by deactivating accounts that are deemed to be fraudulent.

Furthermore, although much of the foregoing discussion is couched in terms of a transaction being a financial transaction such as purchase, it should be understood that “transaction” may comprise many other types of activities that a user might undertake with a user account on e-commerce platform 106. Some such activities may comprise fraudulent or abusive behavior. Embodiments may usefully detect and prevent such abuse.

For example, some e-commerce platforms permit users to write and publish reviews or other feedback about goods or services obtained through the e-commerce platform. It is not uncommon, however, for people to try and game the review system in by publishing a number of fake, glowing reviews of a product. This is typically done to boost sales of a product, but sometimes a vendor on an e-commerce platform may publish fake reviews to attempt to offset other, very negative reviews of their product that were published by other users. Clearly, the reputation of an e-commerce platform may be damaged if it permits such abuse.

Beyond reputation and financial considerations, however, permitting such abuse can undermine the efficiency of the e-commerce platform itself. In the “fake review” example discussed above, such reviews are typically authored and published by a fake account. That is, an account created specifically for the purpose of undertaking abusive activity, and not for any bona fide use of the e-commerce platform. This is true for many types of abusive activity, not just publishing fake reviews. For example, a person may create many accounts again and again in order to continually take advantage of a free trial offered on the e-commerce platform. All of these abusive activities, whether posting fake reviews or creating numerous fake accounts and the like, consume tremendous amounts of storage and processing power. Automated processes for policing non-financial activities are likewise costly in terms of storage and processing. Accordingly, it should be understood that a “transaction” in the context of embodiments of the invention includes non-financial activities, and embodiments may usefully be configured to detect such fraudulent or abusive activities.

### III. Example Computer System Implementation

User device(s) 102A-102N, web server/transaction servers 108, vector generation component 116, fraud detection component 114, data collection component 110, flowchart 200, flowchart 500, flowchart 600, flowchart 700, flowchart 800, flowchart 900, flowchart 1000, flowchart 1100 and flowchart 1200 may be implemented in hardware, or hardware combined with software and/or firmware. For example, vector generation component 116, fraud detection component 114, data collection component 110, flowchart 200, flowchart 500, flowchart 600, flowchart 700, flowchart 800, flowchart 900, flowchart 1000, flowchart 1100 and/or flowchart 1200 may be implemented as computer program code/instructions configured to be executed in one or more processors and stored in a computer readable storage medium. Alternatively, vector generation component 116, fraud detection component 114, data collection component 110, flowchart 200, flowchart 500, flowchart 600, flowchart 700, flowchart 800, flowchart 900, flowchart 1000, flowchart 1100 and/or flowchart 1200 may be implemented as hardware logic/electrical circuitry.

For instance, in an embodiment, one or more, in any combination, of vector generation component 116, fraud detection component 114, data collection component 110, flowchart 200, flowchart 500, flowchart 600, flowchart 700, flowchart 800, flowchart 900, flowchart 1000, flowchart 1100 and/or flowchart 1200 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

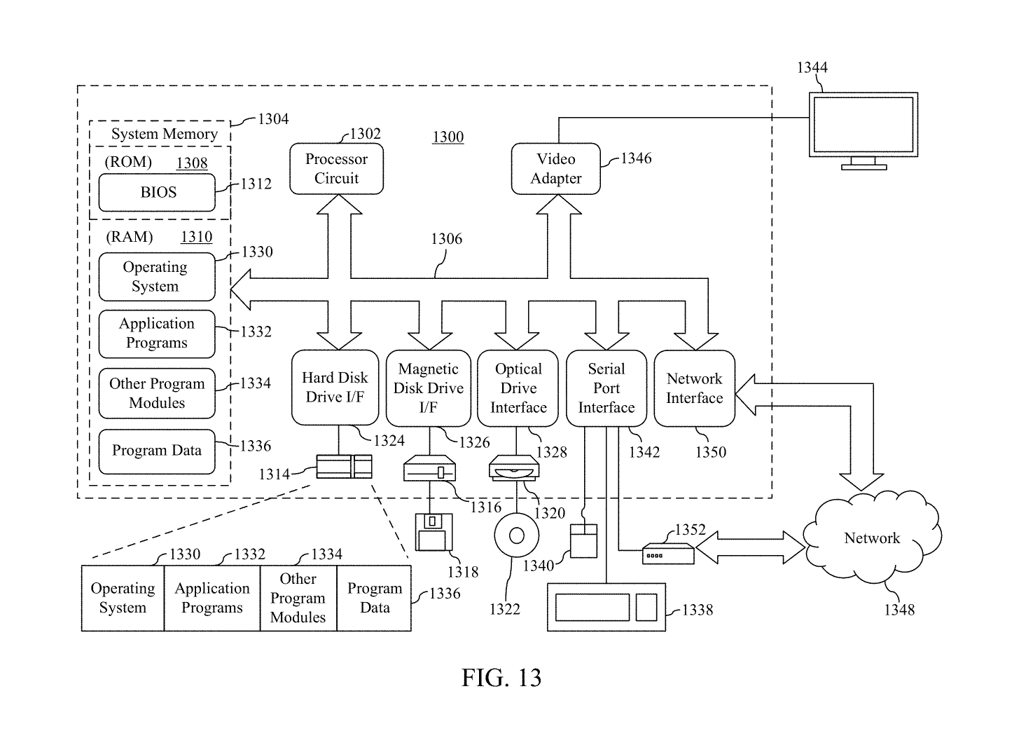

FIG. 13 depicts an exemplary implementation of a computing device 1300 in which embodiments may be implemented. For example, user device(s) 102A-102N, web server/transaction servers 108 may each be implemented in one or more computing devices similar to computing device 1300 in stationary or mobile computer embodiments, including one or more features of computing device 1300 and/or alternative features. The description of computing device 1300 provided herein is provided for purposes of illustration, and is not intended to be limiting. Embodiments may be implemented in further types of computer systems, as would be known to persons skilled in the relevant art(s).

As shown in FIG. 13, computing device 1300 includes one or more processors, referred to as processor circuit 1302, a system memory 1304, and a bus 1306 that couples various system components including system memory 1304 to processor circuit 1302. Processor circuit 1302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1302 may execute program code stored in a computer readable medium, such as program code of operating system 1330, application programs 1332, other programs 1334, etc. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computing device 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1330, one or more application programs 1332, other programs 1334, and program data 1336. Application programs 1332 or other programs 1334 may include, for example, computer program logic (e.g., computer program code or instructions) for implementing vector generation component 116, fraud detection component 114, data collection component 110, flowchart 200, flowchart 500, flowchart 600, flowchart 700, flowchart 800, flowchart 900, flowchart 1000, flowchart 1100 and/or flowchart 1200 (including any suitable step of said flowcharts), and/or further embodiments described herein.

A user may enter commands and information into the computing device 1300 through input devices such as keyboard 1338 and pointing device 1340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1302 through a serial port interface 1342 that is coupled to bus 1306, but may be connected by other interfaces, such as a parallel port, game port, or a universal serial bus (USB).

A display screen 1344 is also connected to bus 1306 via an interface, such as a video adapter 1346. Display screen 1344 may be external to, or incorporated in computing device 1300. Display screen 1344 may display information, as well as being a user interface for receiving user commands and/or other information (e.g., by touch, finger gestures, virtual keyboard, etc.). In addition to display screen 1344, computing device 1300 may include other peripheral output devices (not shown) such as speakers and printers.

Computing device 1300 is connected to a network 1348 (e.g., the Internet) through an adaptor or network interface 1350, a modem 1352, or other means for establishing communications over the network. Modem 1352, which may be internal or external, may be connected to bus 1306 via serial port interface 1342, as shown in FIG. 13, or may be connected to bus 1306 using another interface type, including a parallel interface.

As used herein, the terms “computer program medium,” “computer-readable medium,” and “computer-readable storage medium” are used to refer to physical hardware media such as the hard disk associated with hard disk drive 1314, removable magnetic disk 1318, removable optical disk 1322, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1332 and other programs 1334) may be stored on the hard disk, magnetic disk, optical disk, ROM, RAM, or other hardware storage medium. Such computer programs may also be received via network interface 1350, serial port interface 1342, or any other interface type. Such computer programs, when executed or loaded by an application, enable computing device 1300 to implement features of embodiments discussed herein. Accordingly, such computer programs represent controllers of the computing device 1300.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A fraud detection system is described herein. The fraud detection system, includes: one or more processors; and one or more memory devices accessible to the one or more processors, the one or more memory devices storing software components for execution by the one or more processors, the software components including: a data collection component configured to collect and store at least one usage attribute associated with one or more user actions conducted via a user account of an e-commerce system; a user behavior vector generation component configured to generate at least one feature based at least in part on the at least one usage attribute, the at least one feature reflecting user behavior over a first period of time, and to compute a first user behavior vector using the at least one feature; the data collection component being further configured to collect and store at least one additional usage attribute associated with one or more additional user actions conducted via the user account; the user behavior vector generation component being further configured to generate at least one additional feature based at least in part on the at least one additional usage attribute, the at least one additional feature reflecting user behavior over a second period of time, and to compute a second user behavior vector using the at least one additional feature; and a fraud detection component configured to compare the first and second user behavior vectors to generate a measure of similarity there between, and to determine if a transaction associated with the user account is fraudulent based at least on the measure of similarity.

In one embodiment of the foregoing system, the at least one usage attribute and the at least one additional usage attribute each comprise one or more of: a device identifier; a device IP address; a device IP address location; an email address; a payment instrument; a payment instrument type; or a shipping location.

In another embodiment of the foregoing system, the one or more user actions and the one or more additional user actions each comprise at least one of: signing up for the user account; logging into the user account; associating a payment instrument with the user account; making a purchase with the user account; starting a free trial with the user account; or starting a subscription through the user account.

In another embodiment of the foregoing system, the one or more actions and the one or more additional actions further each comprise using via the user account at least one of: the purchase; the free trial; or the subscription.

In another embodiment of the foregoing system, the at least one feature comprises at least one of: a time of a first use of the at least one usage attribute; a time of a last use of the at least one usage attribute; a total number of uses of the at least one usage attribute; or a total dollar amount spent using the at least one user attribute.

In another embodiment of the foregoing system, the at least one additional feature comprises at least one of: a time of the first use of the at least one additional usage attribute; a time of a last use of the at least one additional usage attribute; a total number of uses of the at least one additional usage attribute; or a total dollar amount spent using the at least one additional user attribute.

In another embodiment of the foregoing system, the fraud detection component is further configured to generate the measure of similarity by performing at least one of: a cosine similarity analysis; an earth mover's distance (EMD) based similarity analysis; a locality sensitive hashing analysis; or a random projection analysis.

In another embodiment of the foregoing system, the fraud detection component is configured to determine if the transaction associated with the user account is fraudulent based at least on the measure of similarity by: providing the measure of similarity as an input to a machine learning model that produces a fraud prediction score based at least in part on the input; and in response to determining that the fraud prediction score exceeds a predefined threshold, identifying the transaction as fraudulent.

In another embodiment of the foregoing system, the first period of time is greater than the second period of time.

A computer-implemented method for detecting fraud in an online commerce system is described herein. The method includes: collecting at least one usage characteristic associated with one or more user actions conducted on the online commerce system via a user account; determining at least one first feature based on each of the collected at least one usage characteristic, the at least one first feature reflecting a statistic associated with the at least one usage characteristic over a first period of time; computing a first usage vector using the at least one first feature; collecting at least one additional usage characteristic associated with one or more additional user actions conducted via the user account; determining at least one second feature based on each of the collected at least one additional usage characteristic, the at least one second feature reflecting a statistic associated with the at least one additional usage characteristic over a second period of time; computing a second usage vector using the at least one second feature; comparing the first and second usage vectors to determine a measure of similarity there between; and determining whether a transaction associated with the user account is fraudulent based at least on the measure of similarity.

In one embodiment of the foregoing method, the at least one usage characteristic and the at least one additional usage characteristic comprise one or more of: a device identifier; a device IP address; a device IP address location; an email address; a payment instrument; a payment instrument type; or a shipping location.

In one embodiment of the foregoing method, the one or more user actions and the one or more additional user actions comprise at least one of: signing up for the user account; logging into the user account; associating a payment instrument with the user account; making a purchase with the user account; starting a free trial with the user account; or starting a subscription through the user account.

In one embodiment of the foregoing method, the one or more actions and the one or more additional actions further comprise using via the user account at least one of: the purchase; the free trial; or the subscription.

In one embodiment of the foregoing method, the at least one first feature comprises at least one of: a time of a first use of the at least one usage characteristic; a time of a last use of the at least one usage characteristic; a total number of uses of the at least one usage characteristic; or a total dollar amount spent using the at least one user characteristic.

In one embodiment of the foregoing method, the at least one second feature comprises at least one of: a time of a first use of the at least one additional usage characteristic; a time of a last use of the at least one additional usage characteristic; a total number of uses of the at least one additional usage characteristic; or a total dollar amount spent using the at least one additional user characteristic.

In one embodiment of the foregoing method, comparing the first and second usage vectors to determine the measure of similarity there between comprises performing at least one of: a cosine similarity analysis; an earth mover's distance (EMD) based similarity analysis; a locality sensitive hashing analysis; or a random projection analysis.

In one embodiment of the foregoing method, determining whether the transaction associated with the user account is fraudulent based at least on the measure of similarity comprises: providing the measure of similarity as an input to a machine learning model that produces a fraud prediction score based at least in part on the input; and in response to determining that the fraud prediction score exceeds a predefined threshold, identifying the transaction as fraudulent.

In one embodiment of the foregoing method, the first period of time is greater than the second period of time.

A computer program product comprising a computer-readable memory device having computer program logic recorded thereon that when executed by at least one processor of a computing device causes the at least one processor to perform operations is described herein. The operations include: collecting first user transaction data associated with one or more transactions conducted via a user account of an online commerce system; determining first features based on the first user transaction data, the first features reflecting user behaviors over a first period of time; computing a first user feature vector using the first features; collecting second user transaction data associated with one or more additional transactions conducted via the user account; determining second features based at least on the second user transaction data, the second features reflecting user behaviors over a second period of time; computing a second user behavior vector using the second features; computing measure of similarity between the first and second user behavior vectors; and determining whether a transaction associated with the user account is fraudulent based at least on the measure of similarity.

In one embodiment of the foregoing computer program product, determining whether the transaction associated with the user account is fraudulent based at least on the difference comprises: providing the difference as an input to a machine learning model that produces a fraud prediction score based at least in part on the input; and in response to determining that the fraud prediction score exceeds a predefined threshold, identifying the transaction as fraudulent.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A fraud detection system, comprising:
one or more processors; and
one or more memory devices accessible to the one or more processors, the one or more memory devices storing software components for execution by the one or more processors, the software components including:
a data collection component configured to collect and store at least one usage attribute associated with one or more user actions conducted via a user account;
a user behavior vector generation component configured to generate at least one feature based at least in part on the at least one usage attribute, the at least one feature reflecting user behavior over a first period of time, and to compute a first user behavior vector using the at least one feature;
the data collection component being further configured to collect and store at least one additional usage attribute associated with one or more additional user actions conducted via the user account;
the user behavior vector generation component being further configured to generate at least one additional feature based at least in part on the at least one additional usage attribute, the at least one additional feature reflecting user behavior over a second period of time, and to compute a second user behavior vector using the at least one additional feature; and
a fraud detection component configured to compare the first and second user behavior vectors to generate a measure of similarity there between, and to determine if a transaction associated with the user account is fraudulent based at least on the measure of similarity.

2. The fraud detection system of claim 1, wherein the at least one usage attribute and the at least one additional usage attribute each comprise one or more of:
a device identifier;
a device IP address;
a device IP address location;
an email address;
a payment instrument;
a payment instrument type; or
a shipping location.

3. The fraud detection system of claim 1, wherein the one or more user actions and the one or more additional user actions each comprise at least one of:
signing up for the user account;
logging into the user account;
associating a payment instrument with the user account;
making a purchase with the user account;
starting a free trial with the user account; or
starting a subscription through the user account.

4. The fraud detection system of claim 3, wherein the one or more actions and the one or more additional actions further each comprise using via the user account at least one of:
the purchase;
the free trial; or
the subscription.

5. The fraud detection system of claim 2, wherein the at least one feature comprises at least one of:
a time of a first use of the at least one usage attribute;
a time of a last use of the at least one usage attribute;
a total number of uses of the at least one usage attribute; or
a total dollar amount spent using the at least one user attribute.

6. The fraud detection system of claim 5, wherein the at least one additional feature comprises at least one of:
a time of the first use of the at least one additional usage attribute;
a time of a last use of the at least one additional usage attribute;
a total number of uses of the at least one additional usage attribute; or
a total dollar amount spent using the at least one additional user attribute.

7. The fraud detection system of claim 1, wherein the fraud detection component is further configured to generate the measure of similarity by performing at least one of:
a cosine similarity analysis;
an earth mover's distance (EMD) based similarity analysis;
a locality sensitive hashing analysis; or
a random projection analysis.

8. The fraud detection system of claim 1 wherein the fraud detection component is configured to determine if the transaction associated with the user account is fraudulent based at least on the measure of similarity by:
providing the measure of similarity as an input to a machine learning model that produces a fraud prediction score based at least in part on the input; and
in response to determining that the fraud prediction score exceeds a predefined threshold, identifying the transaction as fraudulent.

9. The fraud detection system of claim 1, wherein the first period of time is greater than the second period of time.

10. A computer-implemented method for detecting fraud in an online commerce system, comprising:
collecting at least one usage characteristic associated with one or more user actions conducted on the online commerce system via a user account;
determining at least one first feature based on each of the collected at least one usage characteristic, the at least one first feature reflecting a statistic associated with the at least one usage characteristic over a first period of time;
computing a first usage vector using the at least one first feature;
collecting at least one additional usage characteristic associated with one or more additional user actions conducted via the user account;
determining at least one second feature based on each of the collected at least one additional usage characteristic, the at least one second feature reflecting a statistic associated with the at least one additional usage characteristic over a second period of time;
computing a second usage vector using the at least one second feature;
comparing the first and second usage vectors to determine a measure of similarity there between; and
determining whether a transaction associated with the user account is fraudulent based at least on the measure of similarity.

11. The computer-implemented method of claim 10, wherein the at least one usage characteristic and the at least one additional usage characteristic comprise one or more of:
a device identifier;
a device IP address;
a device IP address location;
an email address;
a payment instrument;
a payment instrument type; or
a shipping location.

12. The computer-implemented method of claim 11, wherein the one or more user actions and the one or more additional user actions comprise at least one of:
signing up for the user account;
logging into the user account;
associating a payment instrument with the user account;
making a purchase with the user account;
starting a free trial with the user account; or
starting a subscription through the user account.

13. The computer implemented method of claim 12, wherein the one or more actions and the one or more additional actions further comprise using via the user account at least one of:
the purchase;
the free trial; or
the subscription.

14. The computer-implemented method of claim 11, wherein the at least one first feature comprises at least one of:
a time of a first use of the at least one usage characteristic;
a time of a last use of the at least one usage characteristic;
a total number of uses of the at least one usage characteristic; or
a total dollar amount spent using the at least one user characteristic.

15. The computer-implemented method of claim 14, wherein the at least one second feature comprises at least one of:
a time of a first use of the at least one additional usage characteristic;
a time of a last use of the at least one additional usage characteristic;
a total number of uses of the at least one additional usage characteristic; or
a total dollar amount spent using the at least one additional user characteristic.

16. The computer-implemented method of claim 10 wherein comparing the first and second usage vectors to determine the measure of similarity there between comprises performing at least one of:
a cosine similarity analysis;
an earth mover's distance (EMD) based similarity analysis;
a locality sensitive hashing analysis; or
a random projection analysis.

17. The computer-implemented method of claim 10, wherein determining whether the transaction associated with the user account is fraudulent based at least on the measure of similarity comprises:
providing the measure of similarity as an input to a machine learning model that produces a fraud prediction score based at least in part on the input; and
in response to determining that the fraud prediction score exceeds a predefined threshold, identifying the transaction as fraudulent.

18. The computer-implemented method of claim 10 wherein the first period of time is greater than the second period of time.

19. A computer program product comprising a computer-readable memory device having computer program logic recorded thereon that when executed by at least one processor of a computing device causes the at least one processor to perform operations, the operations comprising:
collecting first user transaction data associated with one or more transactions conducted via a user account of an online commerce system;
determining first features based on the first user transaction data, the first features reflecting user behaviors over a first period of time;
computing a first user feature vector using the first features;
collecting second user transaction data associated with one or more additional transactions conducted via the user account;
determining second features based at least on the second user transaction data, the second features reflecting user behaviors over a second period of time;
computing a second user behavior vector using the second features;
computing measure of similarity between the first and second user behavior vectors; and
determining whether a transaction associated with the user account is fraudulent based at least on the measure of similarity.

20. The computer program product of claim 19, wherein determining whether the transaction associated with the user account is fraudulent based at least on the difference comprises:
providing the difference as an input to a machine learning model that produces a fraud prediction score based at least in part on the input; and
in response to determining that the fraud prediction score exceeds a predefined threshold, identifying the transaction as fraudulent.
